(19) United States
(12) Patent Application Publication
(10) Pub. No.: US 2021/0348437 A1
(43) Pub. Date: Nov. 11, 2021

(54) FRAMELESS WINDOW INSTALLATION ASSEMBLY

(71) Applicant: TEDnovo LLC, Dallas, TX (US)

(72) Inventor: Josue A. VALDEZ, Dallas, TX (US)

(21) Appl. No.: 17/219,486

(22) Filed: Mar. 31, 2021

Related U.S. Application Data
(60) Provisional application No. 63/020,290, filed on May 5, 2020.

(51) Int. Cl. E06B 3/54

(52) U.S. Cl. CPC E06B 3/549

(57) ABSTRACT

A frameless window installation assembly is adapted to be mounted on a building wall, and includes a window sheet unit, and inner and outer bar holders. The window sheet unit has opposite inside and outside surfaces. The inner bar holder is made of metal, is disposed around a periphery of the inside surface, and is adapted to be secured to the building wall. The outer bar holder is made of metal, is disposed around a periphery of the outer side surface, is spaced apart from the inner bar holder, and is adapted to be secured to the building wall. The inner bar holder and the outer bar holder are not directly interconnected by a metal structure. The window sheet unit is secured between the outer and inner bar holders.

### CROSS-REFERENCE TO RELATED APPLICATION

This application claims priority of U.S. Provisional Patent Application No. 63/020290, filed on May 5, 2020.

### FIELD

The disclosure relates to building windows, more particularly to a frameless window installation assembly.

### BACKGROUND

Referring to FIG. 1, a conventional window assembly 9 includes a piece of window sheet 91 and a window frame 92 fixed to a wall 8 for the piece of window sheet 91 to be installed. The window frame 92 is made of metal and includes a frame portion 921 surrounding the window sheet 91, an outer holding member 922 protruding from the frame portion 921 and disposed on the exterior-facing side of the window sheet 91, and an inner holding member 923 protruding from the frame portion 921 and disposed on the interior-facing side of the window sheet 91. The outer holding member 922 and the inner holding member 923 cooperatively form a channel groove 924 for mounting of the window sheet 91, the window sheet 91 is fixed within the channel groove 924 along its periphery, and the gap between the channel groove 924 and the window sheet 91 is normally filled by sealing strips to stop air infiltration and water seepage.

However, it is difficult to conceal the outer holding member 922 of the window frame 92 during architectural design. In addition, the window frame 92 is made of metal material; the thermal insulation effect of this conventional window 9 is relatively poor due to the thermal conductivity of the metal frame portion 921.

### SUMMARY

Therefore, the object of the disclosure is to provide a frameless window installation assembly which provides a window apt to be concealed from view when mounted on the wall and has better thermal insulation effect.

According to the disclosure, a frameless window installation assembly is adapted to be mounted on a building wall. The frameless window installation assembly includes a window sheet unit, an inner bar holder, and an outer bar holder. The window sheet unit has an inside surface and an outside surface that are opposite to each other in an interior-exterior direction. The inner bar holder is made of metal, is disposed around a periphery of the inside surface of the window sheet unit, and is adapted to be secured to the building wall. The outer bar holder is made of metal, is disposed around a periphery of the outer side surface of the window sheet unit, is spaced apart from the inner bar holder, and is adapted to be secured to the building wall. The inner bar holder and the outer bar holder are not directly interconnected by a metal structure. The window sheet unit is secured between the outer bar holder and the inner bar holder.

### BRIEF DESCRIPTION OF THE DRAWINGS

Other features and advantages of the disclosure will become apparent in the following detailed description of the embodiments with reference to the accompanying drawings, of which:

FIG. 1 schematically illustrates the structure of a conventional window assembly;

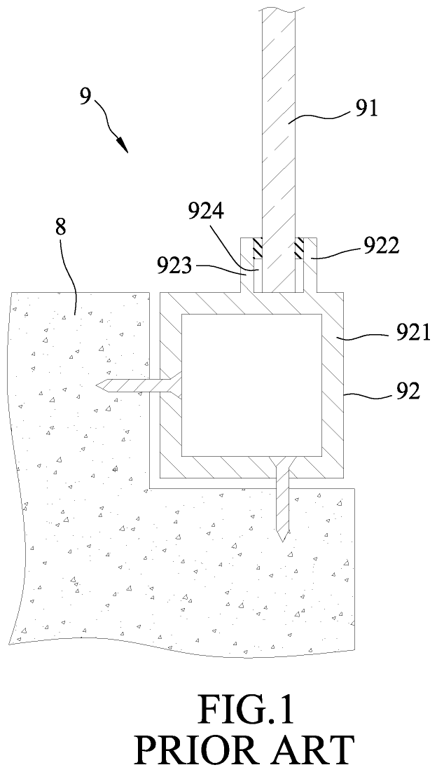

FIG. 2 is a schematic front view of a first embodiment of the frameless window installation assembly according the invention;

FIG. 3 illustrates a fragmentary sectional view of the first embodiment taken along line III-III in FIG. 2 when mounted to a building wall;

FIG. 4 illustrates a fragmentary sectional view of the first embodiment taken along line IV-IV in FIG. 2 when mounted to the building wall;

FIG. 5 is a schematic front view of a second embodiment of the frameless window installation assembly according to the invention;

FIG. 6 illustrates a fragmentary sectional view of the second embodiment taken along line VI-VI in FIG. 5 when mounted to the building wall; and

FIG. 7 illustrates a fragmentary sectional view of the second embodiment taken along line VII-VII in FIG. 5 when mounted to the building wall.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

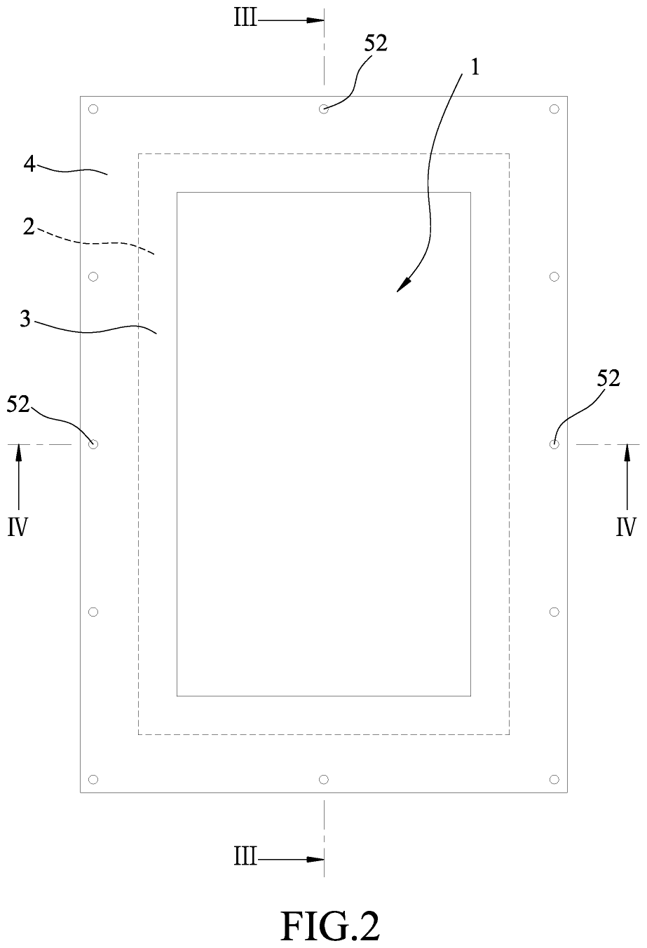

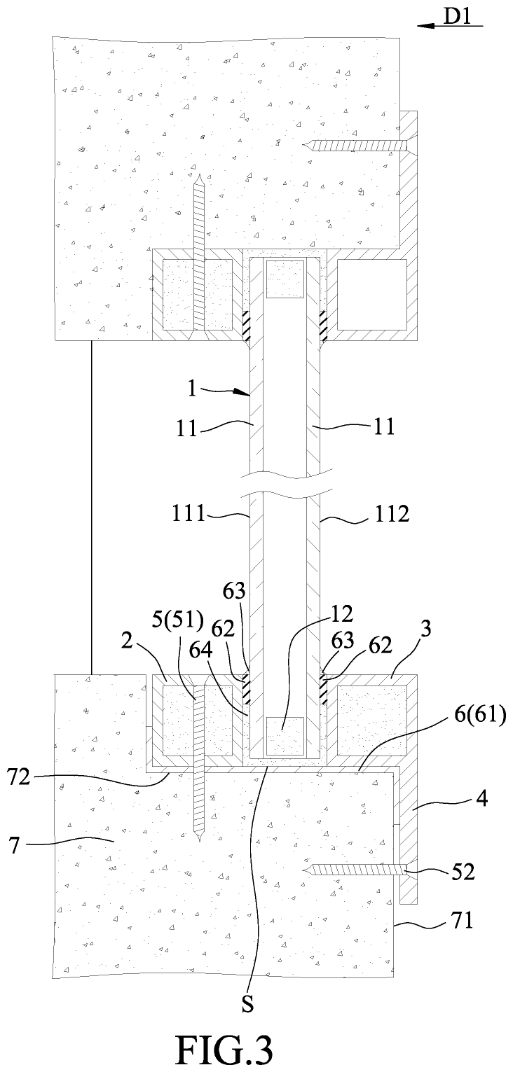

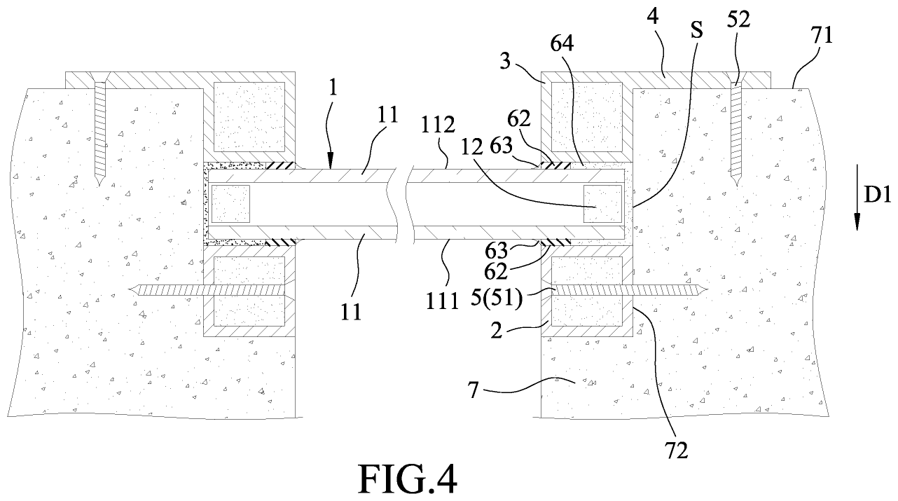

As shown in FIGS. 2, 3 and 4, the first embodiment of the frameless window installation assembly according to this invention is adapted to be mounted on a building wall 7. Specifically, the first embodiment of the frameless window installation assembly is mounted in a window opening of the building wall 7. The building wall 7 has an exterior-facing wall surface 71, and a recessed portion that surrounds the window opening of the building wall 7 and that has an installation surface 72 being transverse to the exterior-facing wall surface 71. In the first embodiment, the installation surface 72 is perpendicular to the exterior-facing wall surface 71 and extending along an interior-exterior direction (D1). The frameless window installation assembly includes a window sheet unit 1, an inner bar holder 2, an outer bar holder 3, an anchoring member 4, a fastener system 5, and an impervious unit 6.

The window sheet unit 1 includes two window sheets 11 juxtaposed with each other in the interior-exterior direction (D1), and a thermal insulation layer 12 disposed between the two window sheets 11. An inner one of the window sheets 11 has an inside surface 111 facing the interior of the building; an outer one of the window sheets 11 has an outside surface 112 facing the exterior of the building (i.e., the inside surface 111 and the outside surface 112 are opposite to each other in the interior-exterior direction (D1)). The inside and outside window sheets 11 are of equal size, and the thermal insulation layer 12 is disposed around and between peripheries of the two window sheets 11. In the first embodiment, the window sheets 11 are made of glass, but the window sheets 11 may be of other materials in other embodiments.

The inner bar holder 2 and the outer bar holder 3 are made of metal, are adapted to be secured to the installation surface 72 of the building wall 7, and are respectively disposed around the peripheries of the inside surface 111 and outside surface 112. The outer bar holder 3 and the inner bar holder 2 cooperatively define a channel (S), and the window sheet unit 1 has a peripheral portion that is received in the channel (S). The inner bar holder 2 and the outer bar holder 3 are not directly interconnected by a metal structure. In other words, no metal structure is provided to directly interconnect the inner bar holder 2 and the outer bar holder 3.

In the first embodiment, each of the inner bar holder 2 and the outer bar holder 3 is tubular and has a rectangular inner space. The tubular form minimizes the material cost and the weight. Moreover, the rectangular tubing is easy to handle and fits common situations. The shape and profile described herein are only for examples and should not be limited thereto. In addition, in the first embodiment, the tubular inner bar holder 2 and the outer bar holder 3 are filled with foam material in order to provide a better thermal insulation effect, but it may be filled with other materials or not filled.

The outer anchoring member 4 is adapted for extending from the outer bar holder 3 in a direction away from the window sheet unit 1 along the exterior-facing wall surface 71. In the first embodiment, the anchoring member 4 is welded to the outer bar holder member 3. In this way, the outer bar holder 3 and the anchoring member 4 can be fabricated separately and this facilitates the fabrication. However, the outer bar holder 3 and the anchoring member 4 may also be fixed to each other in other ways or formed integrally.

The fastener system 5 includes a plurality of first screws 51 which pass through the inner bar holder 2 and the installation surface 72 to fix into the building wall 7, and a plurality of second screws 52 which pass through the anchoring member 4 and the exterior-facing wall surface 71 to fix into the building wall 7. It should be noted that, in other embodiments, the inner bar holder 2 can be fixed to the building wall 7 in different ways, depending on actual conditions. For example, the first screws 51 may lock into the building wall 7 from the inside of the tubular inner bar holder 2.

The impervious unit 6 includes a impervious panel 61 that is adapted to extend through a gap between the inner bar holder 2 and the installation surface 72 of the building wall 7, a gap between the window sheet unit 1 and the installation surface 72, a gap between the outer bar holder 3 and the installation surface 72, and a gap between the exterior-facing wall surface 71 of the building wall 7 and the anchoring member 4. The impervious unit 6 further includes a plurality of airtight sealing strips 62 disposed respectively between the inside surface 111 and the inner bar holder 2 and between the outside surface 112 and the outer bar holder 3, a plurality of overlaid adhesive strips 63 each being disposed outer to a respective airtight sealing strip 62 and near the open end of the channel (S), and a caulk strip 64 disposed inner to the airtight sealing strips 62 in the channel (S) for filling the gap existing among the window sheet unit 1, the inner bar holder 2, the outer bar holder 3, and the impervious panel 61 or the installation surface 72.

As compared with the prior art, in the first embodiment, the outer bar holder 3 is not connected with the inner bar holder 2 through an integral metal structure. Therefore, in the aspect of appearance, a frameless effect can be produced when the outer bar holder 3 and the inner bar holder 2 are concealed from view, which is easier for architects to achieve. In the aspect of cost, the absence of integral metal structural connection between the inner bar holder 2 and the outer bar holder 3 can significantly reduce the material cost which in turn reduces the overall cost. Moreover, the thermal conduction will be reduced since there is no connection between the outer bar holder 3 and the inner bar holder 2 via thermal conductive structure, this will improve the thermal insulation effect of the embodiment.

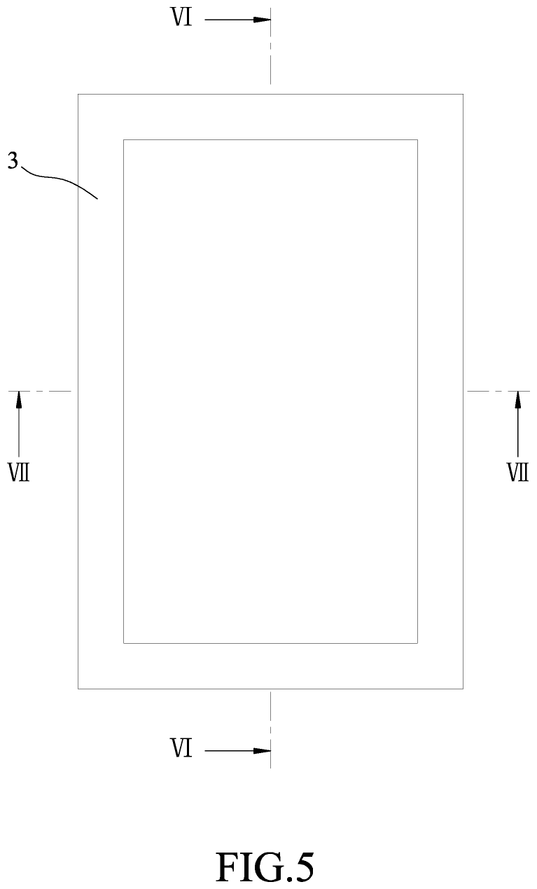

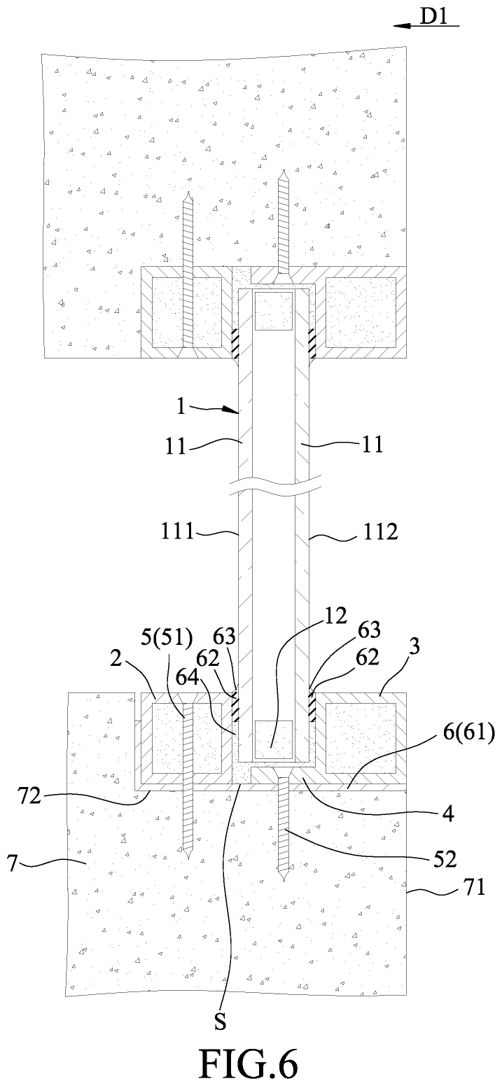

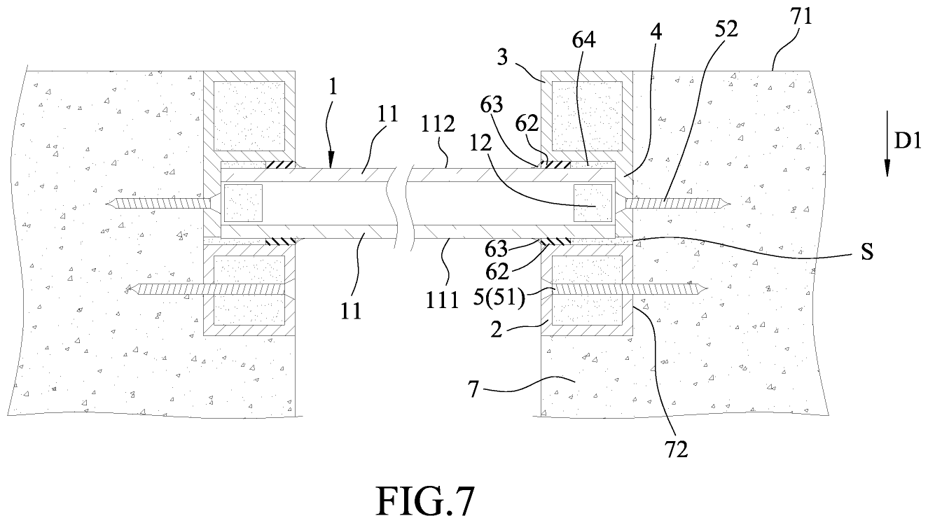

Referring to FIGS. 5, 6 and 7, a second embodiment of the frameless window installation assembly is similar to the first embodiment except that the anchoring member 4 of the second embodiment is adapted to extend along the installation surface 72 of the building wall 7 into the channel (S) and to be disposed below the window sheet unit 1. As shown in FIG. 6, the impervious panel 61 is adapted to extend through the gap between the inner bar holder 2 and the installation surface 72 of the building wall 7, a gap between the anchoring member 4 and the installation surface 72, and the gap between the outer bar holder 3 and the installation surface 72. The second screws pass through the anchoring member 4 and the installation surface 72 to fix into the building wall 7. In this embodiment, the caulk strip 64 is disposed for filling the gap existing among the window sheet unit 1, the inner bar holder 2, the outer bar holder 3, the impervious panel 61, and the installation surface 72.

The second embodiment can achieve the same effect as that of the first embodiment. It is noted that the arrangement of the anchoring member 4 can be adjusted depending on the actual circumstances.

In summary, the frameless window installation assembly of the present disclosure provide the channel holder (S) for the window sheet unit 1, which is constituted by the inner bar holder 2 and the outer bar holder 3 which is not integrally connected with or in contact with the inner bar holder 2 by a metal structure, this makes it easy for architects to conceal the outer bar holder 3 and the inner bar holder 2 in order to create a frameless window appearance, and reduces the overall cost. Furthermore, it provides better thermal insulation effect.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A frameless window installation assembly adapted to be mounted on a building wall, said frameless window installation assembly comprising:
a window sheet unit having an inside surface and an outside surface that are opposite to each other in an interior-exterior direction;
an inner bar holder made of metal, disposed around a periphery of said inside surface of said window sheet unit, and adapted to be secured to said building wall; and
an outer bar holder made of metal, disposed around a periphery of said outer side surface of said window sheet unit, being spaced apart from said inner bar holder, and adapted to be secured to said building wall, said inner bar holder and said outer bar holder being not directly interconnected by a metal structure, said window sheet unit being secured between said outer bar holder and said inner bar holder.

2. The frameless window installation assembly as claimed in claim 1, wherein each of said inner bar holder and said outer bar holder is tubular and has a rectangular inner space.

3. The frameless window installation assembly as claimed in claim 2, wherein each of said inner bar holder and said outer bar holder is filled with foam material.

4. The frameless window installation assembly as claimed in claim 1, wherein said window sheet unit includes:
two window sheets of equal size that are juxtaposed with each other in the interior-exterior direction, an inner one of said window sheets having said inside surface, an outer one of said window sheets having said outside surface; and
a thermal insulation layer disposed between said window sheets and disposed around peripheries of said window sheets.

5. The frameless window installation assembly as claimed in claim 4, wherein said window sheets are made of glass.

6. The frameless window installation assembly as claimed in claim 1, wherein:
said inner bar holder and said outer bar holder are adapted to be secured to an installation surface of said building wall; and
said frameless window installation assembly further comprises
an anchoring member adapted for extending from said outer bar holder in a direction away from said window unit along an exterior-facing wall surface of said building wall which is transverse to the installation surface, and
a fastener system including a plurality of first screws that pass through said inner bar holder for fixing into said building wall, and a plurality of second screws that pass through said anchoring member for fixing into said building wall.

7. The frameless window installation assembly as claimed in claim 6, further comprising an impervious unit, said impervious unit including an impervious panel that is adapted to extend through a gap between said inner bar holder and said installation surface of said building wall, a gap between said window sheet unit and said installation surface of said building wall, and a gap between said outer bar holder and said installation surface of said building wall.

8. The frameless window installation assembly as claimed in claim 7, wherein said impervious panel is adapted to extend into a gap between said anchoring member and said exterior-facing wall surface of said building wall.

9. The frameless window installation assembly as claimed in claim 7, wherein said impervious unit further includes a plurality of airtight sealing strips disposed respectively between said inside surface and said inner bar holder, and between said outside surface and said outer bar holder.

10. The frameless window installation assembly as claimed in claim 1, wherein:
said inner bar holder and said outer bar holder are adapted to be secured to an installation surface of said building wall;
said inner bar holder and said outer bar holder cooperatively define a channel, said window sheet unit having a peripheral portion that is received in said channel; and
said frameless window installation assembly further comprises
an anchoring member extending from said outer bar holder and adapted for extending along the installation surface of said building wall into said channel holder, and
a fastener system including a plurality of first screws that pass through said inner bar holder for fixing into said building wall, and a plurality of second screws that pass through said anchoring member for fixing into said building wall.

11. The frameless window installation assembly as claimed in claim 10, further comprising an impervious unit, said impervious unit including an impervious panel that is adapted to extend through a gap between said inner bar holder and said installation surface of said building wall, a gap between said anchoring member and said installation surface of said building wall, and a gap between said outer bar holder and said installation surface of said building wall.

12. The frameless window assembly as claimed in claim 11, wherein said impervious unit further includes a plurality of airtight sealing strips disposed respectively between said inside surface and said inner bar holder, and between said outside surface and said outer bar holder.
